(19) United States
(12) Patent Application Publication
(10) Pub. No.: US 2011/0203721 A1
(43) Pub. Date: Aug. 25, 2011

(54) INTEGRATED SEALING FOR FUEL CELL STACK MANUFACTURING

(76) Inventors: Mohammad Allama Enayetullah, Sharon, MA (US); Charles Arthur Myers, Medway, MA (US)

(21) Appl. No.: 13/031,114

(22) Filed: Feb. 18, 2011

Related U.S. Application Data
(60) Provisional application No. 61/306,134, filed on Feb. 19, 2010.

(51) Int. Cl. H01M 2/08; B32B 37/12

(52) U.S. Cl. 156/182; 429/508; 429/510

(57) ABSTRACT

A seal and corresponding method of manufacture of stacks enabled by the physical properties of the seal are provided. In the instance of a fuel cell or other electrochemical stack, the seal provides low-cost manufacturing and reliable/durable operation in high temperature (e.g., 120° C. to 250° C.) and acidic environments. The seal provides an elastomeric material characteristic providing resiliency and flexibility, and a protective characteristic that protects the seal from the high temperature acidic environment, such as found in high temperature PEM fuel cells. The seal is affixed to a plate of a fuel cell stack assembly prior to assembly of the stack, such that there is no requirement to apply an adhesive seal, gasket, free flow to solid sealing material, or the like, to each plate during assembly of the fuel cell stack, or during a disassembly and re-assembly process.

### RELATED APPLICATION

This application claims priority to, and the benefit of, co-pending U.S. Provisional Application No. 61/306,134, filed Feb. 19, 2010, for all subject matter common to both applications. The disclosure of said provisional application is hereby incorporated by reference in its entirety.

### FIELD OF THE INVENTION

The invention relates to the fabrication and assembly of multiple units of proton exchange membrane (PEM) fuel cells in a module or stack via compressive lamination of the component parts with integrated sealing provisions. The invention is equally applicable in the assembly and manufacture of high temperature (e.g., 120° C.-250° C.) PEM fuel cell stacks. Further, the invention is also applicable in the assembly/manufacture of modules or stacks of other electrochemical systems including but not limited to electrolyzers and generators/concentrators/purifiers of oxygen and hydrogen gases from relevant electrochemical reactants.

### BACKGROUND OF THE INVENTION

PEM fuel cells are well known in the art; as a power generation device, they convert chemical energy of fuels to electrical energy without their combustion and therefore without any environmental emissions. A PEM fuel cell like any electrochemical cell of the stated categories, is formed of an anode and a cathode interposed by a layer of an electrolyte material for ionic conduction.

Embodiments of the conventional electrochemical cell also include hardware components, e.g., plates, for reactant flow separation, current collection, compression and cooling (or heating). A support plate provides multiple functions: (a) distributes reactant flow at the anode or cathode, (b) collects electrical current from operating anode/cathode surface and (c) prevents mixing or cross-over of the anode and cathode reactants in single cells. An assembly of two or more of these single cells is called a stack of the electrochemical device. A cooling plate (also acting as a support plate) primarily distributes coolant flow in a stack. The number of single cells in a fuel cell stack is generally selected based on a desired voltage of the stack. Conventionally desired voltages include 12 volts, 24 volts, 36 volts, 120 volts, and the like. For convenient assembly and/or dis-assembly of a fuel cell stack with large voltage or power output, multiple sub-stacks or modules, are combined to form the stack. The modules represent stacks of single cells in some number less than what ultimately results in the completed stack, as is well understood by those of ordinary skill in the art. When the stack forms a PEM fuel cell, the stack is often referred to as a PEM stack.

In a conventional PEM stack assembly, sealing of hardware components and active cells for effective separation of anode and cathode reactant-flows and prevention of their leakage and intermixing, is a critical technical issue with direct impact on reliability, durability and ease of manufacturing of the stack. These factors have significant bearing on the cost of the PEM stacks and in turn of the PEM fuel cell based power device. Cost-effective manufacturing of PEM stacks is largely dependent on their sealing process and relevant materials technologies as well as on adaptable hardware design.

Leakage or cross-mixing of reactants and coolant between different cells and multiple elements of a single cell is conventionally prevented by compressive or adhesive seals, which in some instances make use of elastomeric and/or adhesive materials. For example, in U.S. Pat. No. 6,080,503, membrane electrode assembly (MEA) surfaces around the electro-active area are adhesively bonded together with support plates. The adhesive bond is formed of an adhesive agent that encapsulates the edge portion of the MEA. In another example, in U.S. Pat. No. 5,176,966, seals are formed by impregnating the backing layer (gas diffusion layer or GDL) of the electrodes with a sealant material (silicon rubber) which circumscribes the fluid-flow openings and the electro-active portion of the MEAs. Alternatively, the sealant material is deposited into the groves formed on the outer surface of the MEA electrodes; the grooves circumscribing the fluid-flow openings and the electro-active portions of the MEAs. Similarly, in U.S. Pat. No. 5,264,299, a circumferentially complete body of elastomeric sealing material joins the MEA at peripheral portion of porous support plates (anode, cathode, bipolar or cooling plates) and completely fills the pores of said peripheral portions to make it completely impermeable to any fluid. Further, in U.S. Pat. No. 5,284,718, solid preformed gaskets of thermoplastic elastomers are adhered to outer peripheral surfaces of MEAs which form compressive seals against the respective surfaces of support plates, when compressed between compression plates of the stack.

In the sealing means stated above, whether compressive or adhesive, the relevant materials are generally placed upon, fitted, formed or applied to the surfaces being sealed. These processes are labor intensive, costly, and not conducive to high volume manufacturing. The variability of these processes may also compromise reliability/durability of the seals resulting in poor manufacturing yields. Additionally, for a high temperature stack assembly, these sealing processes and/or materials would have compatibility or durability issues due to a highly concentrated acidic environment and high operating temperatures (e.g., 120° C. to 250° C.).

An adhesive sealant based PEM stack assembly process has been described in a World Publication WO 02/43173 based on U.S. patent application Ser. No. 09/908,359, which involves three steps of sealant application to produce a resin-bonded (encapsulated) PEM stack. These three steps are: (1) sealing the unused manifold openings/ports on each of the fluid flow plates with flowfield structure (for example, on the cathode flowfield surface, ports for fuel and coolant flow are sealed about their perimeter to prevent the mixing of these input streams); (2) sealing all ports within the MEAs to prevent the leakage of reactants within the MEA layers; and (3) sealing a remainder of the desired seal surfaces in the stack assembly. The sealing of the remainder of seal surfaces involves layering of all the pre-sealed components within a mold or fixture, introduction of a curable resin (sealant) around the periphery, and forcing the resin into the stacked assembly (cassette) using vacuum transfer molding or injection molding technique. Once cured, the resin provides the structural support and edge sealing over the entire assembly. The resulting fuel cell cassette/stack is held between the compression plates with manifolding and means of compression.

Further advancement of the three-step PEM stack/cassette assembly process is described in the U.S. Pat. No. 7,306,864, which can be conveniently utilized for high volume stack manufacturing using single-step injection molding. In this approach, all the stack components including support plates, plates for stack cooling, compression and current collection, and MEAs, are appropriately layered up and placed in a mold. The sealant material (2-part silicon or other adhesive resin) is forced into the intricate openings (using pressure or vacuum), while the stacked assembly is held under an optimal pressure for minimal resistance between each electrical contact surfaces. When the viscous sealant material fills all the desired sealing spaces (including MEA edges) including the space surrounding the stack assembly, the mold is placed in a low temperature oven to cure the resin. The encapsulated stack is then taken out from the mold.

With regard to the assembly process described in the '864 patent, the adhesive resin materials in this process have stability and/or durability issues at high temperature (e.g., 120° C. to 250° C.) with concentrated acid (e.g., phosphoric acid) environments of high temperature PEM stacks. Suitable materials development is still an ongoing challenge particularly for long term durability of high temperature PEM stacks under their operating conditions. In addition, an adhesively sealed PEM stack is difficult and cumbersome when disassembly/rework or replacement of any of its malfunctioning cells or cell components are required. As such, in many instances, if there is a need for such disassembly or rework, the entire stack is disposed of rather than repaired. This is acceptable for smaller fuel cells and stack assemblies. However, for larger stacks that generate more power (e.g., 1-10 kW high temperature PEM fuel cell), disposal of a faulty stack instead of disassembling and reassembling would be too costly. As such, the present state of the art requires disassembly and reassembly (instead of disposal), which incurs a relatively high cost.

### SUMMARY

There is a need for a durable sealing structure for high temperature PEM fuel cell stacks that enables an efficient and cost effective manufacturing methodology, while also being able to withstand the high temperature (e.g., 120° C. to 250° C.) and acidic (e.g., phosphoric acid) environments to which the seals are exposed during fuel cell operation, and also enabling disassembly and reassembly of the stack without undue effort or expense. The present invention is directed toward further solutions to address this need, in addition to having other desirable characteristics.

In accordance with one example embodiment of the present invention, a fuel cell stack is formed of a plurality of plates. The plates include a seal integrated with the support plates as needed, the seal being suitable particularly for high temperature (e.g., 120° C.-250° C.) and acidic environments, such as those found in high temperature PEM fuel cell stack assemblies. The integrated seal is applied and adhered to each plate, as needed, either prior to or during production of the fuel cell stack. The capability to apply the seal prior to production of the fuel cell stack, enables production of the fuel cell stack without the cumbersome step of applying the seal. With the removal of this step, production of the fuel cell stack is substantially more efficient and cost effective because it can be completed more quickly and result in an improved seal. Furthermore, because there no adhesive bonding between the plate and MEA interfaces, disassembly and re-assembly of the stack is efficient and does not require re-application of adhesive or new seals.

In accordance with one example embodiment of the present invention, a method of constructing a fuel cell stack includes providing a first support plate having a first elastomeric seal previously affixed thereto on a first side and a second elastomeric seal previously affixed thereto on a second side, opposite the first side. A first membrane electrode assembly (MEA) is placed against the first seal of the first support plate. A second support plate is provided having a first elastomeric seal previously affixed thereto on a first side and a second elastomeric seal previously affixed thereto on a second side, opposite the first side. The first elastic seal of the second support plate is placed against the first MEA in such a way that the first MEA, with proper alignment, is sandwiched between the first and second support plates. Additional MEAs and support plates can be placed in an alternating manner a predetermined number of times to build a stack of support plates and MEAs. A first current collector plate is placed against a support plate at a first end of the stack of support plates and MEAs. A second current collector plate is placed against a support plate at a second end of the stack of support plates and MEAs, opposite the first end. First and second compression plates and insulating laminates are placed against the first and second current collector plates, respectively. The stack of support plates and MEAs are compressed together to form the fuel cell stack.

In accordance with one aspect of the present invention, the fuel cell stack includes an assembly of one or more single cells integrated with anode-, cathode- and cooling-plates (including one or more of them in bi-polar configuration), the whole assembly being held compressed between a pair of compression plates where each of the compression plates are in attachment or is integrated with a current collector plate as would be understood by those of ordinary skill in the art.

In accordance with another aspect of the present invention, the anode, cathode, bipolar and cooling plates of the fuel cell stack may be made of electrically conducting solid materials including: (a) metals and metal alloys (including composites), (b) non-metals (carbon, graphite and their composites) and (c) any combination of (a) and (b). The plates may be treated for enhanced performance and may be fabricated by machining, molding, stamping, etching, or similar processes to create: (a) channels for anode/cathode reactants and coolant flow, (b) manifolding of anode/cathode/coolant flows in multiple cells and (c) sealing surface/provision of the said stack.

In accordance with another aspect of the present invention, the manifolding provision of the fuel cell stack may be either external (externally manifolded) or internal (internally manifolded) to the stack assembly itself.

In accordance with another aspect of the present invention, the MEA(s) in the said fuel cell stack may be with or without integrated or bonded gasket(s) and/or sealing provision(s).

### BRIEF DESCRIPTION OF THE FIGURES

These and other characteristics of the present invention will be more fully understood by reference to the following detailed description in conjunction with the attached drawings, in which:

FIG. 1 is a diagrammatic illustration of a stackable plate (with internal manifolding provision) of a fuel cell, according to one embodiment of the present invention;

FIG. 2 is a diagrammatic illustration of a stackable plate (with external manifolding provision) of a fuel cell, according to one embodiment of the present invention;

FIG. 3 is an exploded view of a fuel cell stack, according to one aspect of the present invention;

FIGS. 4A, 4B, and 4C are cross-sectional diagrams of a seal, according to multiple embodiments of the present invention;

FIG. 5 is a flowchart demonstrating one example method of manufacture of a fuel cell stack, in accordance with aspects of the present invention; and

FIG. 6 is a flowchart demonstrating one example method of manufacture of a fuel cell stack, in accordance with aspects of the present invention.

### DETAILED DESCRIPTION

An illustrative embodiment of the present invention relates to a seal, and corresponding method of manufacture enabled by the physical properties of the seal, for PEM fuel cell (and other electrochemical) stacks providing low-cost manufacturing and reliable/durable operation in high temperature (e.g., 120° C. to 250° C.) and acidic environments. The seal and corresponding manufacturing methodology of the present invention are particularly suitable for high temperature (e.g., 120° C. to 250° C.) PEM stack assemblies, but may be utilized in other applications. Conventional stack seals and methodologies prior to the present invention were developed for low temperature (e.g., 100° C. or less) PEM stack assembly fuel cell applications. The seal of the present invention provides an elastomeric material portion, and a protective portion that protects the elastomeric material from the high temperature acidic environment, such as found in high temperature PEM fuel cells. The seal of the present invention is further affixed to a plate of a fuel cell stack assembly prior to assembly of the stack, such that there is no requirement to apply an adhesive seal, gasket, free flow to solid sealing material, or the like, to each plate during assembly of the fuel cell stack. In this approach, the seal of the present invention does not require an installation step during stack assembly, yet it still provides a seal that is capable of withstanding high temperatures (e.g., greater than 120° C.) and acidic (e.g., phosphoric acid) environments found in PEM fuel cell stacks without leakage or cross-mixing of the reactant fluids.

FIGS. 1 through 6, wherein like parts are designated by like reference numerals throughout, illustrate an example embodiment of a seal suitable for high temperature PEM fuel cell stacks, and corresponding method of manufacture of said stacks as enabled by the seal, according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

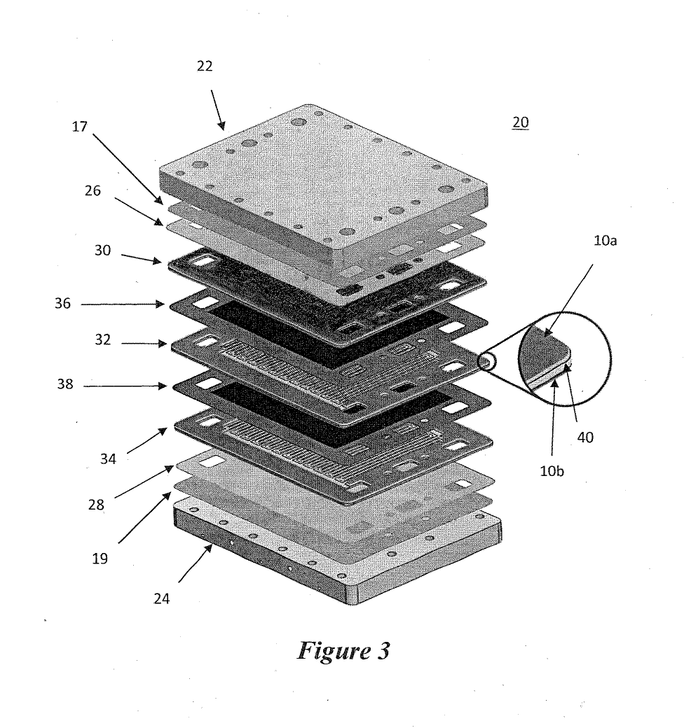

The present invention is shown in FIGS. 1 through 3, which represent a typical surface of an anode, cathode, or bipolar plate in contact with a single cell in a fuel cell stack. The sealing surface on the plate is indicated by cross-hatching in area 1a, 1b around the plates in both figures. Each plate (for example, for fuel, oxidant, and/or coolant flows) in a single cell or a multi-cell module/stack assembly has a sealing surface 1a, 1b of sufficient width (e.g., between about 3 mm and 30 mm) at its outer periphery that surrounds the plate. The sealing surface 1a, 1b is the area upon which the seal rests. It should be noted that the seal need not fill the entire available width of the sealing surface 1a, 1b, rather, it is only necessary for the sealing surface 1a, 1b to have sufficient width (such as, for example, 3 mm to 30 mm) to support the desired portion of the seal upon compression of the stack. However, in accordance with the present invention, a substantial portion of the sealing surface is filled with the seal (see FIG. 3). Flowfield area 2a, 2b, represents the flowfield area, while feeder 3a, 3b represents a feeder or receiver channel (broken bridge structure for supporting the MEA) for anode reactant gas (fuel). The flowfield 2a, 2b may include one or more flow channels in a variety of patterns for even distribution of reactant gases over the active area of anode or cathode through gas diffusion media.

A cathode surface of a cathode or a bipolar plate is also able to be depicted in a similar manner to FIGS. 1-3, except that the flowfield 2a, 2b for a cathode reactant (oxidant) flow may be different from that of the anode-side. FIGS. 1-3 may also represent a typical coolant flow surface with flowfield 2a, 2b different from the anode or cathode flowfield. Another aspect of difference among the surfaces with anode, cathode, and the coolant flowfields is their respective channels for entry 7a, 7b and channels for exit 7′a, 7′b. For a cathode surface, the channels for entry 7a, 7b are, located at channel 5a and channel 5b, respectively. Similarly, exit channels 7′a, 7′b are located at channel 5a and channel 5b, respectively, on the cathode surface. Likewise, the corresponding entry and exit channels on a coolant surface are located at channels 6a, 6b and 6′a, 6′b, respectively.

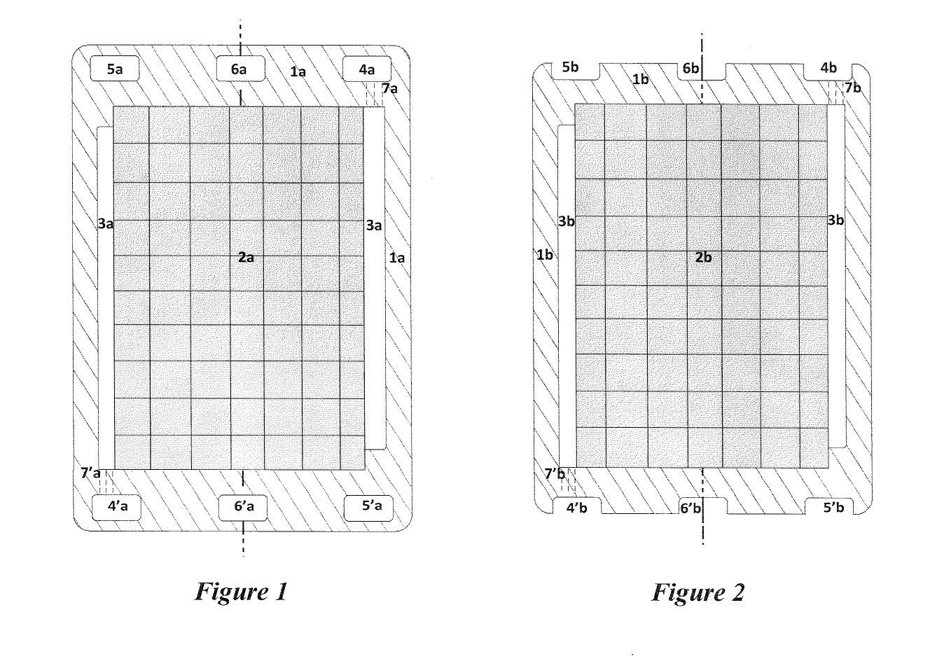

The rectangular cut-outs at channels 4a, 5a, 6a in FIG. 1 represent, respectively, a manifold hole for anode gas at channel 4a, a manifold hole for cathode gas at channel 5a, and a manifold hole for coolant fluid inlets at channel 6a. The corresponding holes for outlets are designated as channels 4′a, 5′a, 6′a. A fuel cell stack assembled with such plates is often referred to as being internally manifolded. The corresponding inlets at channels 4b, 5b, 6b and outlets at channels 4′b, 5′b, 6′b in FIG. 2 are created externally at the outer ends of the plates for the delivery or exit of the fuel, oxidant, and coolant fluid, respectively. A fuel cell stack assembled with such plates is often referred to as an externally manifolded stack. The inlets and outlets in both the plates are directionally reversible for respective materials flow in an assembled stack. Further, all of the channels illustrated herein can vary in size and shape depending on the particular requirements of a specific fuel cell stack assembly and implementation, such that adequate materials flow and desired pressure drops occur. As such, one of ordinary skill in the art will appreciate that the present invention is by no means limited to the specific arrangement and physical properties of these channels as described herein.

In accordance with illustrative examples of the present invention, an electrolyte material is a solid polymer membrane which may be intrinsically ion conducting or may be made ion-conducting by infusion or impregnation of ion-conducting material(s) therein. In this particular illustrative example, the high temperature solid polymer membrane is infused with concentrated (e.g., 80%-100%) phosphoric acid to enable proton conduction. In an embodiment of the said single cell, the anode-membrane-cathode assembly (membrane-electrode assembly, MEA) can either be bonded or non-bonded. However, one of ordinary skill in the art will appreciate that other solid polymer electrolytes may be implemented in conjunction with the present invention.

Two conventional approaches of PEM stack assembly process using (a) compressive load based sealing (using discrete/resilient gaskets or O-rings) and (b) adhesive sealant infusion based sealing (using suitable adhesive resin material) have been discussed herein as conventional sealing solutions having different drawbacks and limitations, particularly with respect to HT PEM stack assembly. The method, the materials, and the process are not commercially practicable for durable HT PEM fuel cell stacks. The sealing methodology of the present invention uses the combination of compressive and adhesive sealing using judicious selection of seal materials and hardware design specific application of these materials on the hardware plates as described herein. Despite the adhesive material of the known fuel cell sealing technologies being considered inappropriate for use in high temperature environments, and despite conventional elastomeric seals being unable to withstand the high temperature acidic environment of a phosphoric acid PEM type fuel cell, the present invention nonetheless combines these technologies to form an acceptable seal that can also increase manufacturing efficiencies. In doing so, the present invention makes use of a high temperature compatible elastomeric material or its composites for the elastomeric seal, and a high temperature compatible adhesive or resilient fluoropolymers, optionally together with a protective layer with proven acid resistance, to form the sealing technology of the present invention.

More specifically, selection of the seal materials that are exposed to the internal environment of the fuel cell is based in part on the criteria of their stability in a strong acid (e.g., phosphoric acid) environment at high temperatures (e.g., 120° C.-250° C.) for long term duration (e.g., 5,000 to 50,000 hours). Selection is further based in part on a desire to have an elastomeric and/or adhesive characteristic to allow for expansion and contraction of the plates and between the plates of the fuel cell stack without degrading or breaching the seal. Suitable materials meeting these criteria may include, but are not limited to, fluoropolymers (e.g., Teflon: PTFE, FEP, TFE, etc), elastomers (e.g., high temperature fluorosilicones, Viton rubber), polyimides, polysulfones, phenoloic resins, etc., suitable composites of these materials and multilayer coatings/laminates of more than one of these materials.

FIG. 3 is an expanded view of a fuel cell stack 20 in accordance with the present invention. First and second compression plates 22, 24 form the top and bottom plates. Adjacent the compression plates 22, 24 are current collector plates 26, 28. An insulator laminate 17, 19 is provided between the compression plates 22, 24 and the current collector plates 26, 28. Adjacent the collector plates are a plurality of hardware plates and MEAs. The hardware plates generally have a bipolar configuration except the terminal hardware plate at each end of the stack, which are unipolar with their flat non-flow-field surfaces facing respective current collector plates 26, 28. As shown in the figure, there is a first hardware plate, 30, a second hardware plate 32, and a third hardware plate 34. Sandwiched between each hardware plate is an MEA. As shown in the figure, there is a first MEA 36, and a second MEA 38. The hardware plate 30, 32, 34 includes a first seal 10a and a second seal 10b, each positioned on opposing sides of a supporting plate 40. The first and second seals 10a, 10b, are adhered to the supporting plate 40 to form each of the first, second, and third hardware plates 30, 32, 34. As such, when building the stack 20 (as described later herein) there is no step required for introducing a seal in-between plates. The seal 10 is already affixed on each side of the hardware plate 30, 32, 34, and is configured for sealing against the MEAs while the terminal plates are compressively sealed or bonded to respective current collector plates 26, 28. This configuration also enables the deconstruction of the stack 20 an easy removal and/or replacement of any one of the plates or MEAs without having to re-apply a seal or seals when the plates are re-stacked. Such a result occurs because each seal is adhesively bonded on only one side, not on both sides. The side without adhesive is simply compressed against another plate in the stack (the MEA being sandwiched in between) at a loading sufficient to prevent leakage through the seal and ensure minimal contact resistance in the stack, as would be understood by those of ordinary skill in the art.

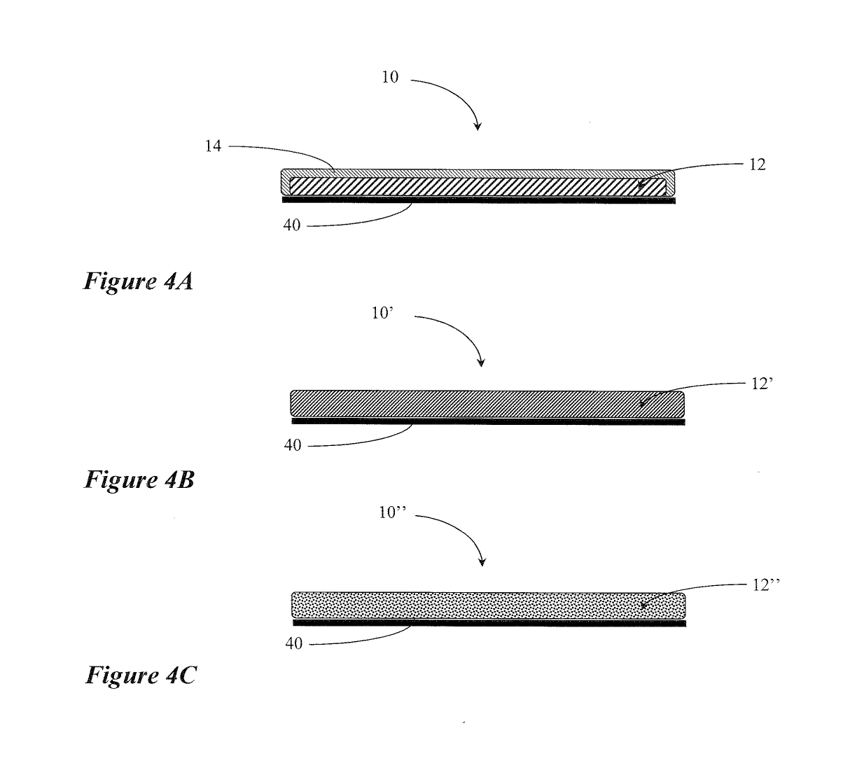

As shown in FIGS. 1, 2, and 3, a seal 10 is placed along the sealing surface 1a, 1b, circumscribing the flowfield, and staying inside of an outer perimeter of the sealing surface 1a, 1b. The seal 10 is continuous, meaning there is effectively no beginning or end, but a continuous seal completely circumscribing the flowfield with no gaps. The elastomeric material is applied and adhesively or mechanically bound to the designated flat sealing surface 1a, 1b around each hardware plate as a continuous layer. The seal 10 is formed of an elastomeric material or its composite with another resilient fluoropolymer (see FIGS. 4A-4C), and is encapsulated by an external protective material, such as a fluoropolymer material. The seal can have numerous different cross-sectional shapes, if desired, including generally circular, polygonal, irregular, or the like. Ultimately, the seal 10 is compressed and its cross-sectional shape potentially altered when the stack is formed and two plates, with the MEA in-between, are pressed together. FIG. 4A is a cross-sectional illustration of an example seal 10 (including seal 10a, 10b in FIG. 3) made in accordance with the present invention. The seal 10 includes an elastomeric material portion 12 in an inner location and a protective material portion 14 which at least substantially circumscribes and encapsulates the elastomeric material portion 12, at least on all sides that would be exposed to the elements of the stack (e.g., high temperature, and acidic environment). The seal is shown adhered to the supporting plate 40. A thin layer of adhesive may reside between the elastomeric material portion 12 and the supporting plate 40, such that the elastomeric material portion 12 adheres to the supporting plate 40. Alternatively, the elastomeric material portion 12 may be mechanically bonded to the sealing surface 1a, 1b of the supporting plate 40.

It should be noted that the seal 10 can alternatively include a composite material that is both elastomeric and maintains an adhesive physical property as well, such that there would not be distinct layers of elastomeric and protective materials. Rather, the materials may be combined into a composite material having both properties in some combination throughout. For example, FIG. 4B shows a seal 10′ having an elastomeric or composite material portion 12′ without the protective layer, and FIG. 4C shows a seal 10″ having an elastomeric or composite material portion 12″ without the protective layer and with additional additives dispersed therein. The seal materials, or the composite material, may contain one or more high temperature/acid resistant filler or additive materials (e.g., glass fibers, aramid fibers, ceramic fibers, silica, alumina, high temperature carbonates, oxides, and the like) as shown in FIG. 4C, provided these additives are electronically non-conducting and non-reactive to the any of the materials in the high temperature MEA or in the support plates. Such additives enhance the durability of the seal in the high temperature and acidic fuel cell environments.

Table A, below, contains a list of suitable elastomeric materials for the seal:

TABLE A
Elastomeric Materials

| Abbreviation | Material Name | Trade Name |
|---|---|---|
| FEPM | TFE/Propylene Rubber | Aflas |
| FKM | Flurocarbon Rubber | |
| | Fluroelastomer | Viton |
| FFKM | Perflurinated Elastomer | Chemraz |
| | Perflurorinated Copolymer | Kalraz |
| | Elastomer | |
| FXM | Fluorinated Copolymer | Fluoraz |
| VMO | Silicone-Rubber | |

Table B, below, contains a list of suitable acid resistant protective materials for the seal:

TABLE B
Protective Materials

| Abbreviation | Material Name | Trade/Brand Name |
|---|---|---|
| FEP | poly(tetrafluoroethylen-co- | Teflon |
| | hexafluoropropylene) | |
| PFA | perfluoroalkoxy polymer | Hyflon |
| PTFE | polytetrafluroethylene | Teflon |
| MFA | poly(tetrafluoroethylene-co- | Korton |
| | perfluro(methylvinylether)) | |
| PEEK | polyetheretherketone | KetaSpire, AvaSpire, Victrex |
| PSU | polysulfone | EpiSpire |
| PPS | polyphenylene sulfide | Primef |
| PAI | polyamide-imide | Torlon |
| PPSU | polyphenylsulfone | Radel, Acudel |
| PESU | polyethersulfone | Veradel |
| LCP | liquid crystal polymer | Xydar, Zenite |
| PPA | polyamide | Zytel |

In accordance with one aspect of the present invention, the fluid-impermeable seal is mechanically or adhesively applied as a flat laminate on the outer surface of both sides of the hardware plates (or one side of the terminal hardware plates) along the peripheral flat surfaces surrounding the respective fluid flowfields and flow channels. For example, the seal materials can be affixed on the flat surfaces sealing surface 1a, 1b of each plate, using vacuum/pressure assisted or injection molding, deposition, coating, bonding, or grafting assisted by heat, pressure- and/or radiation. One of ordinary skill in the art will appreciate that the process utilized to affix the seal 10 to the plate can include one of the above, or any equivalent process, such the present invention is by no means limited to the specific processes listed.

In accordance with another aspect of the present invention, the PEM stack is assembled by layering up of the hardware plates and MEAs in appropriate order and holding the layered assembly between two compression plates under optimal compressive load. The flat laminate of the sealant material on each hardware plates thus creates the desired seal against the corresponding peripheral surface of MEA surrounding its active area. The seal area on each MEA is the edge-sealed portion of the MEA with or without a portion of the electrode/GDL (gas diffusion layer) with surrounding the active MEA area.

In a bi-layer seal, the elastomeric material portion 12 of the seal 10 gives the seal the ability to be compressed, and to expand and contract with temperature changes. The protective layer of the seal, being more resistive to high temperature and acidic environments, protects the elastomeric material portion 14 of the seal 10 from the internal high temperature and acidic environment of the fuel cell.

The manifolding holes on the hardware plates in this invention can be either be internal or external to the main body of the plates; the inlet/outlet ports from these manifold holes for reactants and coolant to and from the respective flowfields are fabricated across the cross-section of the said manifolding holes.

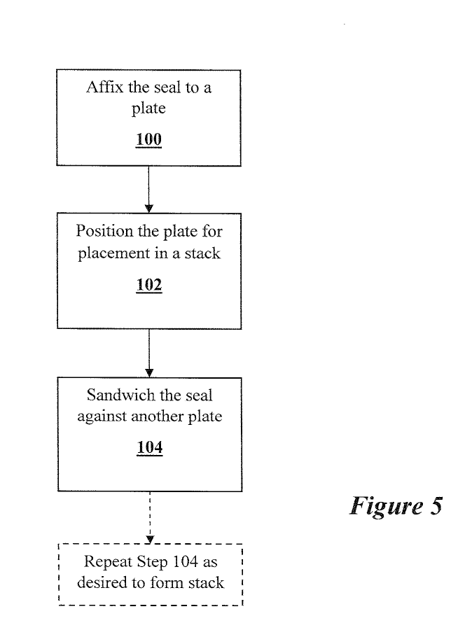

In operation, an example process for manufacturing a fuel cell stack using the seal of the present invention is as follows, as shown in FIG. 5. A seal 10 is first affixed on either side of a supporting plate 40 at area 1a, 1b (step 100) using any of the methodologies described herein. The step of affixing the seal 10 to the plate can be performed well in advance of any stack formation using the plate. The plate with the seal 10 integrated can be stored for a period of time, or shipped to another location for assembly into a stack, or the like. The seal 10 and plate are then positioned for placement in a stack (step 102). The seal 10 and supporting plate 40 are placed against other plates on either side, such that each of the seals 10 is sandwiched between two plates (step 104). This process of stacking can be repeated for the desired number of plates to form a stack, such as the stack illustrated in FIG. 3. The process requires no application of sealing material, or curing, or the like, during or after the stacking process. Once the desired number of plates are sandwiched together, the stack is complete. Thus, the manufacturing process of forming the stack of plates is substantially more efficient than conventional stack forming processes.

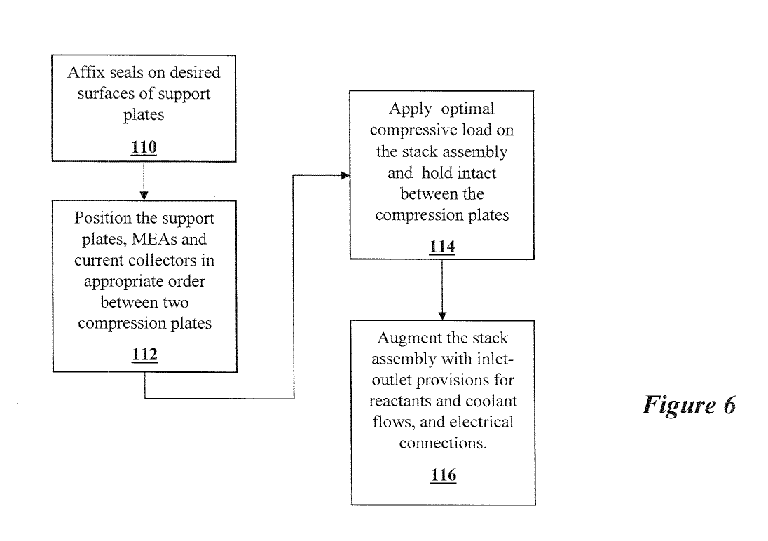

In further accordance with example embodiments of the present invention, an example process for manufacturing a fuel cell stack using the seal of the present invention is as follows, as shown in FIG. 6. Seals are affixed on desired surfaces of support plates (step 110). The support plates, MEAs, and current collectors are then positioned in appropriate order between two compression plates (step 112). More specifically, a first compression plate a first current collector plate, with an insulator laminate therebetween, is positioned in a base position. A single cell or module comprised of an MEA sandwiched between an anode terminal support plate and a cathode bipolar support plate is placed on top of the first current collector plate. Additional modules or single cells, each formed of an anode, MEA, and cathode stacked together, are layered on top of one another up to a predetermined quantity and in such a way that that cooling cells are positioned in regular intervals of single cells. Once the predetermined number of modules or cells has been stacked, the stack is then capped with a combination of a cathode terminal plate, a second current collector and a second compression plate (with an insulator laminate therebetween). The stack assembly is then pressed and held intact under an optimal compressive load using spring-loaded tie-rods or strong bands (step 114). The stack assembly is finally augmented with provisions of inlets and outlets for reactants and cooling fluid, as well as electrical connections, to result in a fuel cell stack (step 116).

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method of constructing a fuel cell stack, comprising:
providing a first support plate having a first elastomeric seal previously affixed thereto on a first side and a second elastomeric seal previously affixed thereto on a second side, opposite the first side;
placing a first membrane electrode assembly (MEA) against the first seal of the first support plate;
providing a second support plate having a first elastomeric seal previously affixed thereto on a first side and a second elastomeric seal previously affixed thereto on a second side, opposite the first side;
placing the first elastic seal of the second support plate against the first MEA in such a way that the first MEA is sandwiched between the first and second support plates;
placing additional MEAs and support plates in an alternating manner a predetermined number of times to build a stack of support plates and MEAs;
placing a first current collector plate against a support plate at a first end of the stack of support plates and MEAs;
placing a second current collector plate against a support plate at a second end of the stack of support plates and MEAs, opposite the first end;
placing a first compression plate and insulator laminate against the first current collector plate;
placing a second compression plate and insulator laminate against the second current collector plate; and
compressing the stack of support plates and MEAs together to form the fuel cell stack.

2. The method of claim 1, wherein the stack of support plates and MEAs is compressed and held together by a pair of compression plates at opposing ends of the stack of support plates and MEAs.

3. The method of claim 1, wherein the seal comprises an elastomeric material and a protective material.

4. The method of claim 1, wherein the seal comprises a composite material having elastomeric and adhesive properties.

5. The method of claim 1, wherein the seal is elastomeric and capable of withstanding operating temperatures of between about 120° C. and about 250° C.

6. The method of claim 1, wherein the seal is capable of withstanding a concentrated acidic environment comparable to the inside of an operating fuel cell without substantially reacting to the acidic environment or degrading in a perceptible manner.

7. The method of claim 1, wherein the seal is previously affixed to the supporting plate using a process selected from a group of processes comprising vacuum/pressure assisted or injection molding, deposition, coating, bonding, or grafting assisted by heat, pressure and/or radiation.

8. The method of claim 1, wherein the seal is comprised of a material selected from a group of resilient materials consisting of, polymers, thermostatic resin materials, thermosets, elastomers, adhesives/epoxies, thermoplastics, fluoropolymers, or combinations thereof.

9. The method of claim 1, wherein the seal comprises one or more filler materials that are electronically non-conducting and non-reactive to materials conventionally found in the fuel cell stack when operating.

10. The method of claim 1, wherein the seal comprises one or more additive materials dispersed therein that are electrically non-conducting, non-reactive to materials conventionally found in proton exchange membrane fuel cells, and are capable of withstanding a concentrated acidic environment in temperature ranges of 120° C. to 250° C. conventionally found in proton exchange membrane fuel cells.

11. The method of claim 1, wherein the seal comprises an elastomeric layer and a protective layer of a resilient material having a relatively higher resistance to acidic environments and temperature ranges of 120° C.-250° C. than the elastomeric layer.

12. A support plate for use in constructing a fuel cell stack, comprising:
a surface circumscribing a perimeter area of the support plate;
a continuous seal affixed to the surface, the seal being elastomeric and suitable to withstand operating temperatures of between about 120° C. and about 250° C. and additionally capable of withstanding an acidic environment, such as the environment found within fuel cell stack when in operation.

13. The plate of claim 12, wherein the seal comprises an elastomeric material and a protective material.

14. The plate of claim 12, wherein the seal comprises a composite material having elastomeric and adhesive properties.

15. The plate of claim 12, wherein the seal is elastomeric and capable of withstanding an acidic environment comparable to the inside of an operating fuel cell without substantially reacting to the acidic environment or degrading in a perceptible manner.

16. The plate of claim 12, wherein the seal is previously affixed to the plate using a process selected from a group of processes comprising vacuum/pressure assisted or injection molding, deposition, coating, bonding, or grafting assisted by heat, pressure and/or radiation.

17. The plate of claim 12, wherein the seal is comprised of a material selected from a group of resilient materials consisting of, polymers, thermostatic resin materials, thermosets, elastomers, adhesives/epoxies, thermoplastics, fluoropolymers, or combinations thereof.

18. The plate of claim 12, wherein the seal comprises one or more filler materials that are electronically non-conducting and non-reactive to materials conventionally found in the fuel cell stack when operating.

19. The plate of claim 12, further comprising a second continuous seal adhered to an opposite side of the plate from the continuous seal.

20. The plate of claim 12, wherein the seal comprises one or more additive materials dispersed therein that are electrically non-conducting, non-reactive to materials conventionally found in proton exchange membrane fuel cells, and are capable of withstanding a concentrated acidic environment in temperature ranges of 120° C. to 250° C. conventionally found in proton exchange membrane fuel cells.

21. The plate of claim 12, wherein the seal comprises an elastomeric layer and a protective layer of a resilient material having a relatively higher resistance to acidic environments and temperature ranges of 120° C.-250° C. than the elastomeric layer
